(19) United States
(12) Patent Application Publication
(10) Pub. No.: US 2018/0290371 A1
(43) Pub. Date: Oct. 11, 2018

(54) HEAT-EMBOSSED NON-WOVEN AND METHOD FOR THE PRODUCTION THEREOF

(71) Applicant: Carl Freudenberg KG, Weinheim (DE)

(72) Inventors: Ralf Kappes, Mainz (DE); Ansgar Komp, Heidelberg (DE); Angela Weik, Bruehl (DE); Sandra Villing-Falusi, Heddesheim (DE); Dominic Kramer, Frankfurt (DE)

(21) Appl. No.: 15/945,743

(22) Filed: Apr. 5, 2018

(30) Foreign Application Priority Data
Apr. 7, 2017 (DE) 10 2017 003 411.7

(51) Int. Cl. B29C 59/02; B29C 59/04; B29C 51/00; B60R 13/02; B29C 59/00; D04H 1/488

(52) U.S. Cl. CPC B29C 59/025; B29C 59/046; B29C 51/004; B29L 2031/3011; B29C 59/005; D04H 1/488; B60R 13/0212

(57) ABSTRACT

A heat-embosssed non-woven that is suitable for producing a decorative layer for a car passenger compartment includes: thermoplastic fibers, being needled and having a maximum tensile elongation of at least 30%; and embossed recesses that have base surfaces at a bottom thereof. A ratio between a thickness of the non-woven in a region of the base surfaces of the recesses and a thickness of the non-woven in a region of the non-embossed regions is at most 0.1. A fraction of a total surface area of the non-woven made up by a total base surface area of the recesses is from 0.5% to 30%.

### CROSS-REFERENCE TO PRIOR APPLICATION

Priority is claimed to German Patent Application No. DE 10 2017 003 411.7, filed on Apr. 7, 2017, the entire disclosure of which is hereby incorporated by reference herein.

### FIELD

The invention relates to a heat-embossed non-woven. The invention further relates to a method for the production thereof, and to the use thereof for producing a decorative layer for car passenger compartments.

### BACKGROUND

Nowadays, car passenger compartments are lined almost exclusively with textile fabrics as a decorative layer. This is important primarily for a positive optical perception, and provides the people in the passenger compartment with a more pleasant sense of space compared with smooth metal or plastics structures. In addition, textile fabrics reflect less sound and absorb more sound than smooth or hard materials.

In the field of textile fabrics, wovens, knitted fabrics and non-wovens are used in particular, wovens being virtually no longer used today on account of the high cost thereof. Knitted fabrics, in contrast, are used very frequently on account of it being possible to also produce very fine structures. However, in this case, installation usually only occurs together with at least one additional layer, often a soft foam, as a lower layer, since the finely structured materials alone would be too susceptible to damage and, per se, also do not exhibit good abrasion resistance to frictional wear on hard surfaces. In addition, knitted fabrics are very susceptible to penetration by adhesives that are generally used for attachment in the passenger compartment.

Non-wovens, in contrast, can also be used as decoration without an additional layer with no problem, because said non-wovens are highly uniform, while also having a high thickness and high fiber coverage of the surface. In this case, carded, transversely laid non-wovens consisting of thermoplastic fibers have been found to be particularly suitable. In this case, the carding process and subsequent transverse laying produces the required orientation of the fibers and the basic interconnection thereof to form a non-woven. The thermoplastic fibers later make possible thermal deformability required for adaptation to the car passenger compartment, and thus ensure good workability in the process steps for producing the roof liner.

In order to ensure sufficient mechanical strength together with good mechanical deformability at high local elongation values, such as arise during thermoforming (order of magnitude of up to 60%), mechanical bonding is carried out in a needling process, following the carding process and subsequent transverse laying. In this way, the necessary tensile strengths and maximum tensile elongation values can be achieved accordingly.

However, in purely mechanically bonded non-wovens, the surface is still relatively susceptible to damage. Therefore, chemical bonding is additionally carried out, following the mechanical bonding. In this case, the fibers are interconnected primarily on the surface, using a polymer binder.

Non-wovens from the prior art, produced in this manner, do not have any embossed pattern apart from slight and usually random structuring from the needle holes. In this aspect, the non-woven has, up to now, been inferior to knitted fabrics which inherently have a regular 3D structure that is visible to the naked eye. It has been found, however, that the presence of visible 3D structures in the passenger compartment of cars is increasingly important, since structures of this kind can optically enlarge the car passenger compartment. This effect is important in particular when there is restricted space in the car. Specifically, the passenger compartment is increasingly restricted due to the use of increasingly thick insulation layers for sound and heat insulation, as well as the use of more and more safety-relevant components such as airbags. The overall size of cars has already increased in recent years, but this is increasingly reaching legal (traffic regulations) and structural limits (road width, parking space width) and is therefore no longer desired by customers either. 3D structuring of surfaces in the car passenger compartment now makes it possible, despite the restricted space, to convey a sense of a more spacious interior design. The roof liner is in particular suitable for this purpose, since said liner occupies a large surface area and thus can be optically enlarged particularly effectively by corresponding structuring of the car passenger compartment.

In order to create the impression of a 3D structured surface, non-wovens are often printed with a specific pattern that produces an optical 3D effect. This purely optical effect, however, is often considered to be inadequate since customers consider it, upon closer inspection, to be an “illusion”. In contrast, the look and feel of true 3D structuring is desired, and this is perceived to be particularly high quality.

U.S. Pat. No. 6,737,114B2 describes a non-woven having a three-dimensional printed surface which is achieved by screen printing the fabric using a “puff pigment”. However, this method is limited in terms of the distinctness of the 3D structure with respect to definition and contour depth. In this case, the greater the contour, the lower the definition of the 3D structuring.

It is also known to provide non-wovens with a heat-embossed pattern in order to create a 3D effect. Heated structured calender rolls are generally used for this purpose. However, the non-wovens conventionally produced by this method have various disadvantages. Said non-wovens either have insufficient structuring depth or are non-wovens that are too compressed and paper-like, having inadequate maximum tensile elongation and thus also inadequate thermoformability.

Too small a structuring depth also results in the non-woven being unsuitable for the thermoforming process, since local smoothing may arise during said process, in particular in the region of the edges. This effect is shown in FIG. 1.

WO 0017435A1 describes moldable and durable textile fabrics, and a method for producing textile fabrics that is suitable for lamination on a contoured surface, for example as a decorative layer in the roof liner in a car or in another motor vehicle. In this case, the textile fabric, which is based on a non-woven, undergoes a stitch-bonding process. Following the step of stitch bonding, the textile fabric is heat-treated, resulting in compaction and shrinkage. A disadvantage of this method is that it is not possible to achieve distinct 3D structuring. The stitches formed have only a poorly developed structure.

### SUMMARY

In an embodiment, the present invention provides a heat-embosssed non-woven that is suitable for producing a decorative layer for a car passenger compartment, the non-woven comprising: thermoplastic fibers, being needled and having a maximum tensile elongation of at least 30%; and embossed recesses that have base surfaces at a bottom thereof, a ratio between a thickness of the non-woven in a region of the base surfaces of the recesses and a thickness of the non-woven in a region of the non-embossed regions being at most 0.1, wherein a fraction of a total surface area of the non-woven made up by a total base surface area of the recesses is from 0.5% to 30%.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

In FIG. 1, d denotes the thickness of the non-woven in the region of the non-embossed regions, and d′ denotes the thickness of the non-woven in the region of the base surfaces of the recesses, in each case before the thermoforming process, and a and a′ denote the corresponding thicknesses after the thermoforming process. As can be seen from the circled region shown in enlargement, the thermoforming causes local smoothing of the 3D structure, in particular at the edges.

FIG. 2 is a cross section of the non-woven according to the invention.

### DETAILED DESCRIPTION

In an embodiment, the present invention provides a heat-embossed non-woven that is suitable for producing a decorative layer for a car passenger compartment, the non-woven containing thermoplastic fibers, being needled and having a maximum tensile elongation of at least 30%, and the non-woven comprising embossed recesses that have base surfaces at the bottom thereof, the ratio between the thickness of the non-woven in the region of the base surfaces of the recesses and the thickness of the non-woven in the region of the non-embossed regions being at most 0.1, and the fraction of the total surface area of the non-woven made up by the total base surface area of the recesses being from 0.5% to 30%.

The non-woven according to the invention has a distinct 3D structure which is mirrored in a ratio between the thickness of the non-woven in the region of the base surfaces of the recesses and the thickness of the non-woven in the region of the non-embossed regions of from 0.005 to 0.1.

Embossed recesses are to be understood as regions of the non-woven which are fused in part at least at the surface and can be perceived visually as a recess. Non-embossed regions are to be understood as regions that have not been provided with an embossed pattern and are therefore not thermally fused or are thermally fused only to a limited extent.

For this reason, the 3D structure can be retained, even in the case of deformation in a thermoforming process, to such an extent as to be able to very effectively optically enlarge the car passenger compartment for example. The non-woven preferably has a ratio between the thickness of the non-woven in the region of the base surfaces of the recesses and the thickness of the non-woven in the region of the non-embossed regions of from 0.005 to 0.1, preferably from 0.01 to 0.1, and in particular from 0.01 to 0.05.

At the same time, the non-woven has high mechanical stability, exhibited by the maximum tensile elongation thereof of over 30%, for example from 30% to 150%. The non-woven preferably has a maximum tensile elongation of from 40% to 150%, more preferably from 40% to 120%, and in particular from 50% to 120%. As a result, the non-woven can be worked without difficulty in a thermoforming process without the non-woven tearing on account of the elongation occurring in the non-woven during the thermoforming process. It was surprising that a non-woven having such a distinct 3D structure, i.e. having such a large ratio between the thickness of the non-woven in the region of the base surfaces of the recesses and the thickness of the non-woven in the region of the non-embossed regions, has such good maximum tensile elongation values. Specifically, on account of the embossing, forming such a distinct 3D structure, the fibers in the non-woven are strongly compressed locally, up to such an extent as to form a polymer film as a conglomerate of a plurality of fibers. However, polymer films have worse maximum tensile elongation values than non-wovens consisting of fibers, since in said non-wovens the fibers can move counter to one another to a certain extent and can thus yield to tensile elongation forces applied over a large region. Surprisingly, high maximum tensile elongation values are also possible in the case of the non-woven according to the invention, despite the distinct 3D structuring. Without specifying a mechanism, it is assumed that this is achieved by adjusting the fraction of the total surface area of the non-woven made up by the total base surface area of the recesses to at most 30%. Since the total base surface area of the recesses occupies only a small fraction of the total surface area of the non-woven, the impairment of the maximum tensile elongation by the embossed regions is not of particular significance.

In a preferred embodiment of the invention, the fraction of the total surface area of the non-woven made up by the total base surface area of the recesses is from 0.5% to 25%, preferably from 0.5% to 20%, more preferably from 0.5% to 15%, in particular from 0.5% to 10%.

According to the invention, the maximum tensile elongation of the non-woven is at least 30%. This high mechanical stability of the non-woven can be achieved at least in part by using a needled non-woven.

Due to the good mechanical properties thereof, the non-woven according to the invention can be used without further layers, in particular without reinforcement layers. This allows simple and cost-effective production.

Particularly good strengths have been found when the non-woven has a needle hole density of from 10/cm² to 2000/cm², preferably from 100/cm² to 1000/cm² and in particular from 200/cm² to 600/cm².

The high mechanical stability of the non-woven according to the invention is also reflected in the fact that said non-woven withstands a high maximum tensile force, for example of over 150 N/5 cm, preferably of from 200 N/5 cm to 1000 N/5 cm, more preferably of from 250 N/5 cm to 1000 N/5 cm, and in particular of from 250 N/5 cm to 600 N/5 cm, and/or can have an abrasion, measured following JIS L 1096, of better than Grade 3, preferably better than Grade 4.

This combination of a distinct 3D structure and simultaneously high mechanical stability can be achieved according to the invention by the heat embossing of the non-woven being carried out using an embossing roller that has an engraving depth of at least the thickness of the non-embossed non-woven, in combination with a comparatively small compacting surface. According to the invention, the non-woven is preferably produced using an embossing roller having an engraving depth of from 0.1 mm to 2.5 mm, more preferably of from 0.25 mm to 2.0 mm, and in particular of from 0.5 mm to 2.0 mm, and a compacting surface of from 0.5% to 30%, more preferably of from 0.5% to 25%, more preferably of from 0.5% to 20%, more preferably of from 0.5% to 15%, in particular of from 0.5% to 10%. In this case, engraving depth is to be understood as the height of the embossing protrusions. If the embossing cylinder has protrusions of different heights, the engraving depth corresponds to the height of the maximum protrusion. The compacting surface is to be understood as the fraction of the surface of the embossing roller that results from the sum of the plateau surfaces of the protrusions. Without a mechanism being specified according to the invention, it is assumed that the large engraving depth of the embossing roller embosses the non-woven only in part, and regions outside the embossed points remain almost unaffected. Accordingly, according to the invention the non-woven preferably comprises non-embossed regions that are wherein they are not thermally fused or are thermally fused only to a limited extent. The fraction of said non-embossed regions is advantageously from 50 to 100%.

Moreover, the large engraving depth of the embossing roller makes it possible to retain the original thickness of the material outside the compacted points. This is advantageous since it allows for optimum use to be made of the laminating function of the non-woven. Specifically, substrates generally used in car passenger compartments often contain glass fibers which have to be completely covered.

Using embossing rollers having a large engraving depth, i.e. of at least the thickness of the non-embossed non-woven, is unusual since laborious measures, for example slow process control, have to be taken in order to prevent perforation.

According to the invention, the recesses are particularly preferably ultrasound-embossed. As a result, the non-embossed regions can be kept almost unaffected in a particularly simple manner. At the same time, the ultrasound makes it possible to introduce sufficient energy at the recesses, despite the spatial proximity, in order to achieve film formation on the fibers. As a result, a material that has a large ratio between the thickness of the non-woven in the region of the base surfaces of the recesses and the thickness of the non-woven in the region of the non-embossed regions, and thus also a distinct 3D structure, can be obtained in a particularly precise manner. Moreover, in the event of thermal deformation, ultrasound-embossed recesses remain intact or are altered only to such a small extent that this is imperceptible to the naked eye.

The thermoplastic fibers are preferably staple fibers. The staple fibers preferably have a fiber length of from 10 mm to 80 mm, more preferably from 20 mm to 60 mm, and in particular from 30 mm to 60 mm.

The embossed regions advantageously have an aspect ratio of from 4:1 to 1:2, preferably from 4:1 to 1:1, and in particular from 3:1 to 1:1. These aspect ratios make it possible to design the distinct 3D structuring in a particularly attractive manner, as a result of which the selected pattern can be emphasized.

Again advantageously, the embossed regions of the non-woven have a depth of from 0.1 mm to 2.5 mm, more preferably from 0.25 mm to 2.0 mm, in particular from 0.5 mm to 2.0 mm. At these depths, the recesses are particularly easy to detect, visually and haptically.

In order for it to be possible to heat-emboss the non-woven, said non-woven preferably comprises thermoplastic fibers, preferably in an amount of at least 50 wt. %, for example from 50 wt. % to 99 wt. %, more preferably from 70 wt. % to 95 wt. % and in particular from 90 wt. % to 95 wt. %, in each case based on the total weight of the non-woven. A further advantage of using thermoplastic fibers is that said fibers simultaneously allow thermoforming. The thermoplastic fibers advantageously have a melting point of from 100° C. to 300° C., more preferably from 150° C. to 300° C., and in particular from 200° C. to 300° C. Using thermoplastic fibers of this kind makes it possible to optimally combine good stability of the materials during use, and simultaneously good workability.

A very wide variety of thermoplastic fibers can be used. Thermoplastic fibers that contain polyester, in particular polyethylene terephthalate, polybutylene terephthalate, polytrimethylene terephthalate, polylactide, polycaprolactone, polyamide, in particular polycaprolactam, polyamide-6,6, polyamide-11, polyamide-12, or polyolefin, in particular polypropylene, polyethylene, polystyrene, and mixtures and/or copolymers thereof, have been found to be particularly suitable.

The thermoplastic fibers advantageously have a fiber titer of from 0.1 denier to 10 denier, more preferably from 1 denier to 6 denier, and in particular from 1.5 denier to 4 denier. At these finenesses, the bulkiness and the retractive force of the fibers, in conjunction with the desired soft feel, can be achieved particularly effectively.

The mass per unit area of the non-woven can also vary. For example, masses per unit area in the range of from 50 g/m² to 500 g/m², more preferably from 100 g/m² to 300 g/m², more preferably from 100 g/m² to 250 g/m², and in particular from 150 g/m² to 250 g/m², have been found to be suitable. At these masses per unit area, both the desired thickness for completely covering the underlying substrate, and the necessary maximum tensile elongation for the thermoforming step, can be achieved particularly successfully.

According to the invention, the non-woven preferably has a thickness in the range of from 0.25 mm to 2.5 mm, preferably from 0.5 mm to 2.5 mm, more preferably from 0.5 mm to 2.0 mm, and in particular from 1.0 mm to 2.0 mm.

In order to improve the binding of the fibers at the surface (abradability), the non-woven can preferably comprise a polymer binder layer on at least one surface. Said layer preferably comprises polyacrylates, polystyrene, polyurethanes, polycarbonates, polyvinyl acetate-ethylene copolymers, the mixtures and copolymers thereof, in particular in a fraction of more than 90 wt. % based on the total weight of the binder layer.

For this purpose, it has been found to be favorable for the polymer binder layer to have a mass per unit area of from 5 g/m² to 50 g/m², preferably from 5 g/m² to 40 g/m², more preferably from 5 g/m² to 30 g/m².

The present invention further relates to a method for producing a heat-embossed non-woven that has a maximum tensile elongation of at least 30% and is suitable as a decorative layer for car passenger compartments, said method comprising the following steps:
providing a needled non-woven comprising thermoplastic fibers,
heat-embossing the non-woven such that the non-woven is provided with embossed recesses that have base surfaces at the bottom thereof, the ratio between the thickness of the non-woven in the region of the base surfaces of the recesses and the thickness of the non-woven in the region of the non-embossed regions being at most 0.1, and the fraction of the total surface area of the non-woven made up by the total base surface area of the recesses being from 0.5% to 30%.

The method according to the invention is suitable in particular for producing a non-woven according to the invention in accordance with one or more of the embodiments described herein. The preferred embodiments described above with regard to the non-woven according to the invention are therefore intended to also relate, mutatis mutandis, to the method according to the invention, as preferred embodiments thereof.

In a first method step, a needled non-woven comprising thermoplastic fibers is provided or produced. Using a needled non-woven makes it possible to obtain a non-woven having a higher maximum tensile force.

In a preferred embodiment, the needling is carried out such that a needle hole density of from 10/cm² to 2000/cm², preferably from 100/cm² to 1000/cm² and in particular from 200/cm² to 600/cm² is achieved.

The non-embossed non-woven can be produced in the conventional ways known to a person skilled in the art. If, as is preferred according to the invention, staple fibers are used, said fibers are expediently first carded and laid to form a non-woven fabric. This can be followed by thermal pre-bonding, followed by the needling step.

During heat-embossing, the fraction of the total surface area of the non-woven that is made up by the total base surface area of the recesses is set to between 0.5% and 30%. This can be achieved by appropriately selecting the sealing surface of the embossing roller. Said surface is accordingly preferably also from 0.5% to 30%.

During heat-embossing, the non-woven is further provided with embossed recesses that have base surfaces at the bottom thereof, the ratio between the thickness of the non-woven in the region of the base surfaces of the recesses and the thickness of the non-woven in the region of the non-embossed regions being at most 0.1. This can be achieved by adjusting the engraving depth of the embossing roller.

Heated embossing rollers are preferably used, for example having a temperature of from 180° C. to 240° C. Said rollers advantageously have an engraving depth of from 0.1 mm to 2.5 mm. In a further preferred embodiment, the embossing is carried out using an embossing roller having an engraving depth that corresponds at least to the thickness of the non-woven in the region of the non-embossed regions. This is advantageous since the non-embossed regions are compressed less, which has a positive effect on the optical and mechanical properties of the non-woven.

In a particularly preferred embodiment of the invention, embossing of the non-woven is carried out in the form of ultrasonic embossing. Thermoplastic materials can be excited and fused by the ultrasound, making it possible to introduce embossed patterns.

In contrast with the use of heated embossing rollers, in the case of ultrasonic embossing, the energy can be introduced by means of high-frequency excitation of an ultrasonic anvil. This is advantageous since it is thus possible to work using significantly lower temperatures and the energy can be introduced into the desired regions of the non-woven in a targeted manner. As a result, the specific ratio between the thickness of the non-woven in the region of the embossed regions and the non-embossed regions can be adjusted in a particularly consistent, reproducible and precise manner. Moreover, ultrasonic embossing has particularly high process stability. A further significant advantage of this method is that the non-embossed regions are particularly unaffected here, i.e. neither compressed nor fused, which has a positive effect on the optical and mechanical properties of the non-woven.

The invention further relates to a heat-embossed non-woven that can be produced by means of a method according to one or more of the embodiments above.

The non-woven according to the invention according to one or more of the embodiments described is ideal for producing a decorative layer for car passenger compartments, since said non-woven combines a distinct 3D structure with good mechanical stability and in particular good thermal deformability. According to the invention, the non-woven is particularly preferably used for producing a roof liner for car passenger compartments.

A further embodiment of the invention comprises a thermally deformed non-woven according to the invention according to one or more of the embodiments described.

In a preferred embodiment, following thermoforming around an edge having an angle of 90, the non-woven has embossed recesses in the region of the deformation, which recesses have base surfaces at the bottom thereof, the ratio between the thickness of the non-woven in the region of the base surfaces of the recesses and the thickness of the non-woven in the region of the non-embossed regions being at most 0.1.

The parameters specified in the above description are determined as follows:

Maximum tensile elongation: Measurement according to the test specification in accordance with DIN EN 29073-3 at a deformation speed of 200 mm/min.

Maximum tensile force: Measurement according to the test specification in accordance with DIN EN 29073-3 at a deformation speed of 200 mm/min.

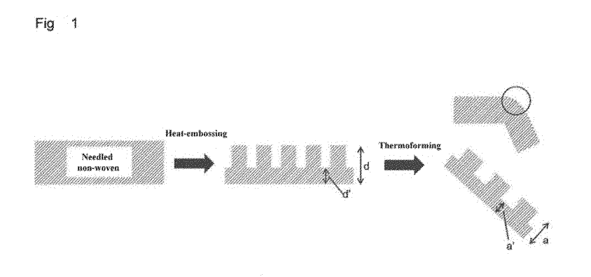

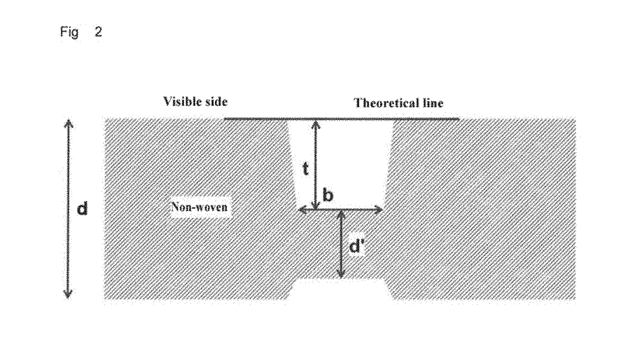

Thickness of the non-woven in the region of the base surfaces of the embossed recesses: A cross section of the non-woven is prepared using a scalpel. In the process, it should be ensured that said cross section comprises at least 5 recesses. Alternatively, a plurality of cross sections can also be prepared. Subsequently, the thickness of the non-woven is measured in the region of the base surfaces of the recesses (denoted d′ in FIG. 2) using a suitable microscope, preferably an electron microscope. The measurement is taken for at least 5 different recesses, in each case at least 3 points per recess.

Thickness of the non-woven in the region of the non-embossed regions: Measurement according to the test specification in accordance with DIN EN ISO 9073-2.

Mass per unit area: Measurement according to the test specification in accordance with EN 29073-T1. In order to determine the mass per unit area, three 100×100 mm samples are punched out in each case, and the samples are weighed and an average value is calculated.

Depth of the embossed regions: A cross section of the non-woven is prepared using a scalpel. In the process, it should be ensured that said cross section comprises at least 5 recesses. Alternatively, a plurality of cross sections can also be prepared. Subsequently, the depth of the embossed regions (denoted tin FIG. 2) is determined, using an electron microscope, as the vertical spacing between a theoretical line (see FIG. 2) at the level of the surface of the non-embossed regions, and the base surface of the recesses (denoted b in FIG. 2). In the process, in each case at least 5 embossed regions are measured, at least 3 points per embossed region in each case.

Aspect ratio: A cross section of the non-woven is prepared using a scalpel. In the process, it should be ensured that said cross section comprises at least 5 recesses at the widest point thereof. Alternatively, a plurality of cross sections can also be prepared. Subsequently, the diameter of the recesses at the base surface is determined (denoted b in FIG. 2). In each case at least 5 embossed regions are measured, and an average value is calculated. The aspect ratio results from the ratio of the depth (denoted tin FIG. 2) and the measured diameter of the base surface.

Abrasion: The abrasion is determined using the Taber abrasion tester according to JIS L 1096, abrasion wheel CS-10, across 150 cycles at a load of 500 gf per arm, using a round sample having a diameter of 120 mm. Grades of 1 to 5 are given for assessment, the following applying:

Grade 5: Only slight traces of abrasion can be identified.

Grade 4: The surface is roughened in part, traces of abrasion can be identified.

Grade 3: The surface is roughened, but no material has yet been removed from the interior of the non-woven.

Grade 2: The surface is roughened, and material has also been removed from the interior of the non-woven.

Grade 1: The surface is significantly roughened, underlying material shows through.

Fraction of the total surface area of the non-woven made up by the total base surface area of the recesses: The diameter of the base surface of the recesses is first measured. At the widest point of the embossed regions (denoted b in FIG. 2) of 5 embossed regions is determined and an average value is calculated. On the basis of this value, and taking account of the geometry, the base surface area of the embossed regions is determined and the fraction of the total surface area of the non-woven is calculated.

Melting point of the thermoplastic fibers: Measurement according to the test specification in accordance with DIN EN ISO 11357-3, at a heating rate of 10° C./min.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heat-embosssed non-woven that is suitable for producing a decorative layer for a car passenger compartment, the non-woven comprising:
thermoplastic fibers, being needled and having a maximum tensile elongation of at least 30%; and
embossed recesses that have base surfaces at a bottom thereof, a ratio between a thickness of the non-woven in a region of the base surfaces of the recesses and a thickness of the non-woven in a region of the non-embossed regions being at most 0.1,
wherein a fraction of a total surface area of the non-woven made up by a total base surface area of the recesses is from 0.5% to 30%.

2. The non-woven according to claim 1, wherein the embossed regions comprise ultrasound-embossed regions.

3. The non-woven according to claim 1, wherein an aspect ratio of the embossed regions is of from 4:1 to 1:2.

4. The non-woven according to claim 1, having a thickness in the range of from 0.25 mm to 2.5 mm.

5. The non-woven according to claim 1, wherein the non-woven comprises a polymer binder layer on at least one surface.

6. The non-woven according to claim 1, wherein, following thermoforming around an edge having an angle of 90°, the non-woven has a ratio, in a region of the deformation, between the thickness of the non-woven in the region of the base surfaces of the recesses and the thickness of the non-woven in the region of the non-embossed regions of at most 0.1.

7. A method for producing a heat-embossed non-woven that is suitable as a decorative layer for car passenger compartments, the method comprising the following steps:
providing a needled non-woven comprising thermoplastic fibers;
heat-embossing the non-woven; and
providing the non-woven with embossed recesses that have base surfaces at a bottom thereof,
wherein a ratio between the thickness of the non-woven in a region of the base surfaces of the recesses and a thickness of the non-woven in a region of the non-embossed regions is at most 0.1, and
wherein a fraction of a total surface area of the non-woven made up by a total base surface area of the recesses is from 0.5% to 30%.

8. The non-woven produced using the method according to claim 7.

9. Use of a non-woven according to claim 1 as a decorative layer for car passenger compartments, and in particular as a roof liner.

10. The use according to claim 9, wherein the non-woven undergoes a thermoforming process in order to be adapted to the car passenger compartment.

11. The non-woven according to claim 3, wherein the aspect ratio of the embossed regions is of from 4:1 to 1:1.

12. The non-woven according to claim 11, wherein the aspect ratio of the embossed regions is of from 3:1 to 1:1.

13. The non-woven according to claim 4, wherein the thickness is in the range of from 0.5 mm to 2.5 mm.

14. The non-woven according to claim 13, wherein the thickness is in the range of from 0.5 mm to 2.0 mm.

15. The non-woven according to claim 14, wherein the thickness is in the range of from 1.0 mm to 2.0 mm.

16. The non-woven according to claim 5, wherein the binder layer contains polyacrylates, polystyrene, polyurethanes, polyvinyl acetate-ethylene copolymers, the mixtures and copolymers thereof.
